(19) United States
(12) Patent Application Publication
(10) Pub. No.: US 2022/0083840 A1
(43) Pub. Date: Mar. 17, 2022

(54) SELF-TRAINING TECHNIQUE FOR GENERATING NEURAL NETWORK MODELS

(71) Applicant: Google LLC, Moutain View, CA (US)

(72) Inventors: Thang Minh Luong, Mountain View, CA (US); Quoc V. Le, Sunnyvale, CA (US); Qizhe Xie, Pittsburgh, PA (US)

(21) Appl. No.: 17/018,555

(22) Filed: Sep. 11, 2020

(51) Int. Cl. G06N 3/04; G06N 20/00

(52) U.S. Cl. CPC G06N 3/0454; G06N 20/00

(57) ABSTRACT

Methods, systems, and apparatus, including computer programs encoded on a computer storage medium, used to implement a self-training technique for generating neural network (NN) models. A first model is generated in response to training a first NN using labeled data. A respective pseudo label is generated for each item of unlabeled data when items of unlabeled data are processed using the first model. A second NN is used to process each item of a combined dataset to train the second NN. The combined dataset includes items of labeled data and a corresponding item for each respective pseudo label. Attributes of items in the combined dataset are modified to inject noise into the combined dataset when the second NN is trained. A second model is generated after the second NN is trained by processing items in the combined dataset, including processing items that represent the noise injected into the combined dataset.

### BACKGROUND

This specification relates to techniques for self-training a neural network.

Neural networks are machine-learning models that employ one or more layers of operations to generate an output, e.g., a classification, for a received input. Some neural networks include one or more hidden layers in addition to an output layer. The output of each hidden layer is used as input to the next layer in the network, i.e., the next hidden layer or the output layer of the network. Some or all of the layers of the network generate an output from a received input in accordance with current values of a respective set of parameters.

Some neural networks include one or more convolutional neural network (CNN) layers. Each convolutional neural network layer has an associated set of kernels. Each kernel includes values established by a neural network model generated using a computing system. In some implementations, kernels identify particular image contours, shapes, or colors. Kernels can be represented as a matrix structure of weight inputs. Each convolutional layer can also process a set of activation inputs. The set of activation inputs can also be represented as a matrix structure.

### SUMMARY

Techniques are described which include an iterative framework of steps for self-training a neural network to generate a trained predictive model. The techniques can be used to generate neural network models that achieve improved accuracy for data recognition tasks, including reductions in mean corruption error for such tasks, relative to prior approaches. Although some examples reference images, the techniques described in this document can be used as an improved method of training neural network models to more accurately perform a variety of predictive tasks relating to data recognition, classification, speech recognition, etc.

An example computing system is used to perform or execute steps of the described techniques. The system can include one or more special-purpose hardware circuits that are each configured to implement a neural network, such as a CNN, that includes multiple neural network layers. The techniques include training a first data model on labeled data, such as labeled images of an ImageNet dataset. For example, the techniques' iterative framework that represents a self-training method can be evaluated using an ImageNet classification dataset that has 1000 image classes.

The first data model can be represented by a neural network implemented on a hardware circuit and the labeled images are processed through the layers of the neural network to learn or train the first data model. For example, the first data model is trained or learned to recognize attributes of items depicted in the images at least with reference to the corresponding labels that are descriptive of the items' attributes. The first data model that is trained on the labeled images is used as a “teacher” model to generate pseudo labels on a dataset of unlabeled images. The computing system is used to train a larger, second data model as a “student” model on the combination of labeled and pseudo labeled images. The second data model can be represented by the same neural network, or a different neural network, implemented on a hardware circuit.

The system iterates the training process by putting back the student as the teacher. For example, the system is configured to iterate the training process by re-identifying or configuring the trained student model as a new teacher model. The techniques include injecting noise into training datasets processed during certain steps of the overall training process. For example, the first data model that corresponds to the teacher is not noised when the first model is learned or during generation of the pseudo labels. However, during the learning of the second data model that corresponds to the student, the system injects noise into the combined dataset of labeled and pseudo labeled items (images). The noise is injected to force the student model to endure a harder, more complex, or more challenging learning process than the teacher. In some implementations, the system is configured to add noise to both an input (e.g., the training data) and the student model itself.

One aspect of the subject matter described in this specification can be embodied in a computer-implemented method. The method includes obtaining data specifying a trained first machine-learning model that has been trained on labeled data, where each of the labeled data and the first machine-learning model are un-noised when the first machine-learning model is trained and the first machine-learning model is a neural network. The method further includes generating first pseudo labeled data by generating a respective pseudo label for each of a plurality of items of unlabeled data by processing the items of unlabeled data using the trained first machine-learning model; and training a second machine-learning model on a first combined dataset, where the first combined dataset comprises the labeled data and the first pseudo labeled data and the second machine-learning model is a neural network. During the training noise is added to the second machine-learning model, which includes (i) modifying attributes of one or more items in the first combined data set, (ii) modifying operations performed by the second machine-learning model, or (iii) both.

These and other implementations can each optionally include one or more of the following features. For example, in some implementations, the method includes: generating second pseudo labeled data by generating a respective pseudo label for each of the plurality of items of unlabeled data by processing the items of unlabeled data using the trained second machine-learning model; and training a third machine-learning model on a second combined dataset that includes the labeled data and the second pseudo labeled data.

In some implementations, training the second machine-learning model includes: training a machine-learning model that has a respective model size that is larger than a respective model size of the first machine-learning model that has been trained on the labeled data. In some implementations, training the second machine-learning model includes: training one or more subsequent versions of the second machine-learning model; and increasing a respective size of each subsequent version of the second machine-learning model, relative to a respective size of a corresponding prior version of the second machine-learning model that preceded the subsequent version.

Training the third machine-learning model can include: training the third machine-learning model based on each of the subsequent versions of the second machine-learning model. In some implementations, training the third machine-learning model includes: adding noise to the third machine-learning model by modifying attributes of one or more items in the second combined data set using a noise function. In some implementations, training the second machine-learning model includes: during the training, applying a noise function to a particular neural network layer of the neural network that is used to implement the second machine-learning model; adding noise to the second machine-learning model based on the noise function applied to the particular neural network layer; and modifying operations performed by the second machine-learning model as a result of adding the noise to the second machine-learning model.

Generating the respective pseudo label for each of the plurality of items of unlabeled data includes: generating the respective pseudo label based on a maximum predicted probability for a class that corresponds to a particular item of unlabeled data in response to processing the particular item of unlabeled data using the trained first machine-learning model. Modifying attributes of the one or more items in the first combined dataset includes: modifying attributes of the one or more items in the first combined dataset to inject noise into the first combined dataset concurrent with processing the one or more items through layers of the neural network to train the second machine-learning model, wherein the neural network is used to implement the second machine-learning model.

In some implementations, the first machine-learning model is implemented using a teacher neural network model; the second machine-learning model represents a first version of a student neural network model; and the third machine-learning model represents a second, different version of a student neural network model. The first neural network and the second neural network can have the same neural network architecture.

Other implementations of this and other aspects include corresponding systems, apparatus, and computer programs, configured to perform the actions of the methods, encoded on computer storage devices. A computing system of one or more computers or circuits can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The subject matter described in this specification can be implemented in particular embodiments to realize one or more of the following advantages. The described techniques present a streamlined method of self-training neural network models that achieve improved accuracy relative to prior models for image recognition tasks relating to images of an example ImageNet dataset. For example, the described techniques can be used as a self-training method to generate a neural network model that achieves greater than 80% (e.g., 88.4%) top-1 accuracy on ImageNet. This threshold accuracy can be achieved using a large dataset of unlabeled images, e.g., 300 million (“300M”) unlabeled images, and training techniques that include deliberate injection of noise into datasets processed by subordinate (e.g., student) data models during one or more iterations of the overall self-training method.

Further, the self-training method described in this specification not only improves accuracy for recognition tasks on standard ImageNet datasets, the method also improves classification robustness by large margins on much harder or more challenging test sets. For example, the self-training method can be used to generate a trained model that improves ImageNet-A top-1 accuracy from approximately 16% (e.g., 16.6%) to 74% (e.g., 74.2%). The self-training method can also be used to generate models that reduce ImageNet-C mean corruption error (mCE) from approximately 45 (e.g., 45.7) to 31 (e.g., 31.2) and ImageNet-P mean flip rate (mFR) from approximately 27 (e.g., 27.8) to 16 (e.g., 16.1).

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 shows an example computing system for implementing a self-training technique for generating neural network models.

FIG. 2 shows an example process of a self-training technique used to generate a neural network model.

FIG. 3A shows an example representative algorithm for a self-training technique used to generate a neural network model.

FIG. 3B illustrates an example of noisy student training.

FIG. 4 shows a graph with example graphical data about the performance of different models with respect to self-training techniques.

FIG. 5 shows a graph with example graphical data about model performance for different types of pseudo labels.

FIG. 6 shows a graph with example graphical data about model performance for a noised model.

FIG. 7 shows results data with accuracy values for different types of models.

FIG. 8 shows results data with accuracy values for different types of noised models.

FIG. 9 shows an example neural network model for performing data recognition.

Like reference numbers and designations in the various drawings indicate like elements.

### DETAILED DESCRIPTION

Deep learning has shown remarkable successes in image recognition in recent years. However, some state-of-the-art (“SOTA”) vision models are still trained with supervised learning which requires a large corpus of labeled images to work well. Because these SOTA vision models are shown only labeled images, the models make limited use of unlabeled images that are available in much larger quantities to improve accuracy and robustness.

In this context, techniques are described for using unlabeled images to generate image recognition models that improve upon the accuracy of the SOTA models that are learned using only the labeled images. The described techniques also demonstrate that the gain in accuracy has an outsized impact on the robustness of the models. For this purpose, the described approach uses a much larger corpus of unlabeled images, where some images may not belong to any category in the ImageNet database.

The example predictive models described in this specification are trained using a self-training framework (e.g., an algorithm) which includes three main steps: 1) train a teacher model on labeled images; 2) use the teacher to generate pseudo labels on unlabeled images, and 3) train a student model on the combination of labeled images and pseudo labeled images. These three main steps may correspond to a representative algorithm. The algorithm can include a fourth step in which the algorithm is iterated by treating the student as a teacher to generate new pseudo labels for training a new student. For example, the algorithm may be iterated for at least two or three training cycles. In some examples, the algorithm is iterated as needed to achieve a desired accuracy or based on a given sample size of data.

An additional element of the representative algorithm is the deliberate injection of noise or noise components during certain steps of the overall training cycles. Specifically, the student model is noised during its training/learning process, whereas the teacher model is not noised during the generation of the pseudo labels. The injection of the noise component forces the noised student model to learn attributes of data items in a manner that is harder or more difficult relative to the learning process of the un-noised teacher model. Various techniques or methods can be used to noise the student model during its training/learning processes. Example methods for injecting noise during training of the student model include a dropout method, a data augmentation method, a stochastic depth method, or combinations of each.

The general technique may be described as a method of self-training a neural network model by using a noisy student to emphasize the role that noise plays in providing robust methods for training models that can achieve more accurate results relative to models developed using other approaches. In some implementations, to generate a final model that performs accurately, the student model is appropriately sized to leverage a threshold number of unlabeled images.

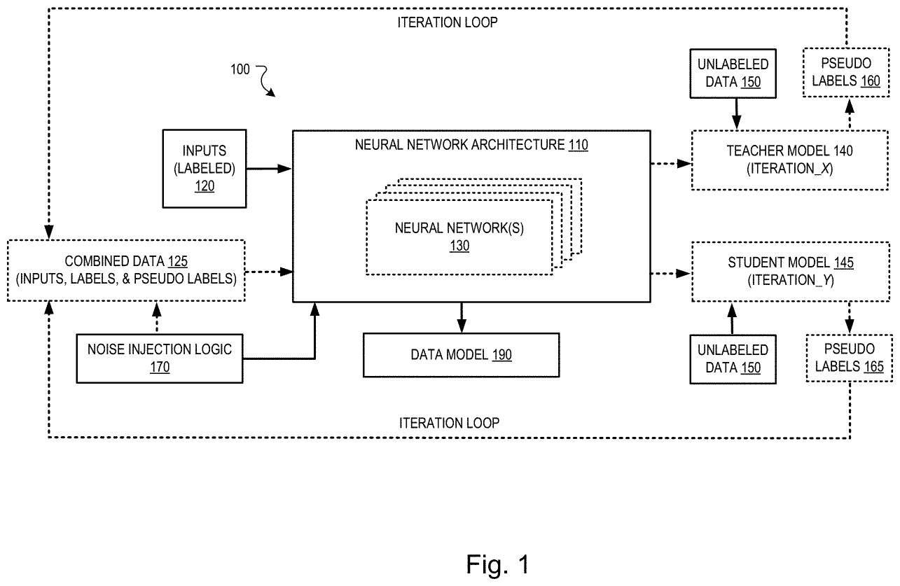

FIG. 1 shows an example computing system 100 for implementing a self-training technique for generating neural network models.

System 100 generally includes an example neural network architecture 110 (e.g., multiple CNN) that processes an input dataset 120 of labeled data to learn or generate a trained data model 190 (described below). The architecture 110 can be represented as a single neural network 130 or a system of multiple neural networks 130 where each neural network 130 of the system corresponds to a respective type of neural network or deep neural network (DNN), such as a CNN or RNN. In some implementations, the graphic of neural network 130 represents layers of a multiple layer neural network or DNN.

As described in more detail below, the system 100 uses the neural networks 130 to generate different types of trained data models and different types of labels (e.g., pseudo labels) for a given training or data processing iteration of the architecture 100. The types of trained models include a teacher model 140 that may be generated during a first iteration and a student model 145 that may be generated during a second, different iteration. The different types of labels are generated for corresponding items of unlabeled data 150 that are processed through layers of the neural networks 130 during two or more processing iterations executed at system 100. In some implementations, the different types of labels generated for corresponding items of unlabeled data 150 are pseudo labels 160, 165.

Processes performed using the system 100 and architecture 110 can include multiple iterations of processing datasets to train different iterations of teacher models 140 and students 145 that are used to generate pseudo labels 160, 165. As shown in the example of FIG. 1, the teacher model generates pseudo labels 160, whereas the student model 145 generates pseudo labels 165. The system 100 can include X number of iterations (e.g., iteration_X) that are each used to generate a particular version of a teacher model 140 and Y number of iterations (e.g., iteration_Y) that are each used to generate a particular version of a student model 145.

For example, during a first iteration (e.g., iteration_X) a teacher model 140 is learned from labeled inputs 120 and used to generate pseudo labels 160. During a second iteration (e.g., iteration_Y) a student model 145 is learned from a combined dataset 125 that includes labeled inputs 120 and the pseudo labels 160 generated by the teacher model 140 during the first iteration. The system 100 includes noise injection logic 170 that is used to modify attributes of data items (e.g., images) in the combined dataset 125 to inject noise into the combined dataset 125 when a version of a student model 145 is being learned.

Hence, during the second iteration (e.g., iteration_Y) the student model 145 is learned from a combined dataset 125 that includes labeled inputs 120, the pseudo labels 160 generated by the teacher model 140 during the first iteration, and noise components associated with various data items in the combined dataset. The student model 145 that is learned from the combined dataset 125 (e.g., that includes the noise) can be used to generate pseudo labels 165 that are fed back to form a new combined dataset 125 to be processed at a subsequent processing iteration.

The system 100 is configured to iterate these data processing steps by putting back the student model 145 as a teacher model 140 to generate new pseudo labels 160 and train a new student model 145 during a subsequent processing iteration of architecture 110. This iterative data processing scheme represents a self-training technique that can be run for multiple iterations to generate a self-trained data model 190 that is adapted to perform recognition tasks with improved accuracy relative to other models and relative to prior versions of teacher and student models that are learned at system 100.

Each of X and Y are integers greater than one. When the processing iterations of X and Y are handled sequentially, X can be an integer greater than or equal to one, whereas Y can be an integer greater than or equal to two. Each of pseudo labels 160, 165 that are generated during a first iteration are fed back to form a combined dataset 125 of inputs, labels, and pseudo labels that can be processed using the neural networks 130 during a second or subsequent iteration.

Each of the teacher model 140 and the student model 145 may be represented by one or more of the neural networks 130 included in architecture 110. The architectures for the student and teacher models can be the same or different. For example, one or more neural networks 130 (or architectures) that are used to generate data models representing the teacher 140 can be the same neural network architecture, or different than, the architecture of neural networks 130 used to generate data models representing the student 145. In some implementations, the described techniques of injecting noise into the combined data set processed by the student model 145 requires that the student model 145 be sufficiently sized or large enough to fit a combined dataset 125 of labeled data items or images and pseudo labeled data items or images. For this purpose, the system 100 is configured to include an example neural network architecture 110 that has large capacity for processing the individual items of the combined dataset 125.

The system 100 can be configured to include neural networks 130, or neural network architectures 110, that are based on the known EfficientNet architectures or architectures that have a larger capacity than the known ResNet architectures. In some implementations, the system 100 includes an architecture 110 that uses one or more EfficientNet models as baseline models because they provide better capacity for handling larger amounts of data relative to the size of data that can be handled by other types of models. In some implementations, the system 100 includes various types of EfficientNet models that can be scaled (e.g., up or down) as needed, for example, based on a desired parameter size for fitting different types of images or data items.

Some EfficientNet models of system 100 can be scaled up (or further scaled up) to obtain model versions that are wider and deeper than a prior model version, where the scaled up version can allow for more parameters to fit a large number of unlabeled images with similar training speed as a prior version. For example, the system 100 is operable to further scale up an EfficientNet-B7 model to obtain EfficientNet-L0, -L1, and -L2 model versions. The system 100 can further scale up an EfficientNet-B7 model to obtain an EfficientNet-L0 model that is wider and deeper than the prior EfficientNet-B7 model. In some examples, a first model (e.g., EfficientNet-L0) is scaled up to a second model (e.g., EfficientNet-L1) by increasing a width of the first model. The system 100 is operable to perform compound scaling and scale all dimensions of a prior model (e.g., -L1) to obtain an EfficientNet-L2 model.

Example architecture specifications of EfficientNet-L0, L1, and L2 are listed in Table 1 below. Architecture specifications for the EfficientNet-B7 model are also listed in Table 1 as a reference. As shown in Table 1, scaling the width and resolution by c leads to c² times training time and scaling depth by c leads to c times training time. Hence, EfficientNet-L0 can have around the same training speed as EfficientNet-B7 but EfficientNet-L0 also has more parameters that give it a larger capacity.

TABLE 1
Architecture specifications for EfficientNet models

| Architecture name | w | d | r | Test Res. | # Params |
|---|---|---|---|---|---|
| EfficientNet-B7 | 2.0 | 3.1 | 600 | 600 | 66M |
| EfficientNet-L0 | 2.8 | 3.7 | 380 | 600 | 140M |
| EfficientNet-L1 | 3.9 | 3.7 | 380 | 600 | 273M |
| EfficientNet-L2 | 4.3 | 5.3 | 475 | 800 | 480M |

In Table 1 the width w and depth d are the scaling factor that needs to be contextualized in EfficientNet. The parameters “r” and “Test Res.” in Table 1 denote training and test resolution, respectively.

Due to the large model size, the training time of an EfficientNet-L2 model can be longer, e.g., approximately five times longer, than the training time of an EfficientNet-B7 model. Also, using the EfficientNet-L1 model can approximately double the training time compared to using the EfficientNet-L0 model. In some implementations, the training time of EfficientNet-L2 can be around 2.72 times the training time of EfficientNet-L1.

Referring again to FIG. 1, the student is sized to be larger than the teacher. This difference in sizing can enable the configuration of the student to learn a more powerful model that corresponds to the configuration of the teacher. Also, the injection of noise and sizing of the student model relative to the teacher model are relevant differences between the teacher-student framework described in this specification and prior teacher-student approaches whose main goal is often model compression.

The system 100 is configured to perform data balancing with reference to different types and classes of data items. For example, because classes in ImageNet can have a similar number of labeled images, the system 100 is configured to balance a number of unlabeled images for each class and generate duplicates images in classes where the system determines there are not enough images for a given class. The system 100 may also determine that a given class has too many images. For these classes, the system 100 is operable to select images for a given class with the highest confidence scores, as determined from a predicted label of the image. This process is described in more detail below. The process of generating the pseudo labels 160, 165 can include generating multiple “soft” pseudo labels. The soft labels can be pseudo labels 160, 165 that are more stable and lead to faster convergence, particularly when an example teacher model 140 has an observed accuracy that is below a particular threshold accuracy.

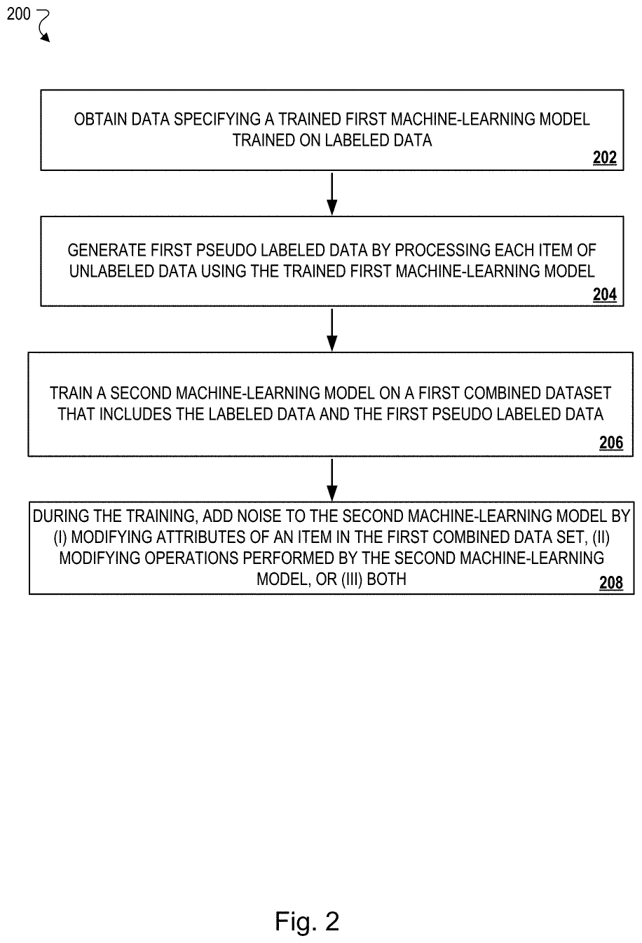

FIG. 2 shows an example process 200 that pertains to a self-training technique used to generate a neural network model, such as an example teacher model or student model described above with reference to FIG. 1. In some implementations, the process 200 corresponds to an algorithm for a self-training method that process inputs to iteratively improve the accuracy with which a learned model can perform a particular task. The inputs to the algorithm are both labeled and unlabeled data items, such as images. The process 200 can be run for multiple iterations to generate a self-trained data model that is adapted to perform recognition tasks with improved accuracy relative to other models.

Referring now to process 200, as noted above the system 100 uses labeled data (e.g., images) to train a first machine-learning model that represents a teacher model 140. The system 100 obtains data specifying the trained first machine-learning model that has been trained on labeled data (202). Each of the labeled data and the first machine-learning model are un-noised when the first machine-learning model is trained. In some implementations, the teacher model 140 represented by the first machine-learning model is trained using the standard cross entropy loss.

The system 100 generates first pseudo labeled data by generating a respective pseudo label for each item of multiple items of unlabeled data by processing the items of unlabeled data using the trained first machine-learning model (204). For example, the system 100 uses the teacher model 140 to generate a respective pseudo label for each item of unlabeled data 150 in response to processing items of unlabeled data 150 using the teacher model 140. The pseudo labels 160 can be soft (e.g., a continuous distribution) or hard (e.g., a one-hot distribution). In some implementations, the system 100 implements a pseudo labeling process that uses the network predictions of the first data model as soft pseudo labels. In some implementations, a pseudo labeling approach of system 100 uses network class predictions as hard labels for the unlabeled samples.

The pseudo labels can also be target classes for unlabeled data that are used as if they were true labels. For example, the system 100 is operable to use the first data model to generate one or more pseudo labels for a predicted target class of a given data item or sample image based on a corresponding probability for that target class. The system 100 can then select the class which has a maximum predicted probability for each unlabeled sample. In some implementations, for a set of unlabeled data, the pseudo labels generated for the items of unlabeled data are used as if they were true labels.

The system 100 is configured to train a second machine-learning model that represents a student model (206). The system trains the second machine-learning model on a first combined dataset that includes the labeled data and the first pseudo labeled data. For example, the system 100 trains the second model by using one or more of the neural networks 130 of architecture 110 to process inputs in a combined dataset. More specifically, the architecture 110 trains or learns the second model by processing each item of combined dataset 125, which includes data items of labeled data 120 and the corresponding data item for each of the respective pseudo labels generated using the teacher model 140. Training the second machine-learning model includes training a machine-learning model that has a respective model size that is larger than a respective model size of the first machine-learning model that was trained on the labeled data 120.

The system 100 is configured to add noise to the second machine-learning model during the training of the second machine-learning model (208). The system 100 adds the noise, for example, by (i) modifying attributes of an item in the first combined data set, (ii) modifying operations performed by the second machine-learning model, or (iii) both. The system 100 is configured to modify attributes of data items (e.g., images) in the combined dataset 125 to inject noise into the combined dataset. For example, the system 100 uses the noise injection logic 170 to inject noise into the combined dataset when at least one neural network 130 of architecture 110 is trained to learn a second model that represents the student model 145. The noise injection logic 170 is configured to noise the student model 145 based on different methods for injecting noise. For example, the noise injection logic 170 can use dropout, data augmentation, stochastic depth, or combinations of each to inject noise by modifying attributes of images during training.

To noise the student model 145, the noise injection logic 170 is operable to generate noise functions that are based on stochastic depth, dropout, or a RandAugment algorithm (e.g., data augmentation). In some implementations, a respective noise function for each noise injection method includes hyperparameters. The hyperparameters for these noise functions can be the same for the different types of models, e.g., EfficientNet-B7, L0, L1 and L2 models, that are trained using architecture 110. The system 100 can use the noise injection logic 170 to set a survival probability in stochastic depth to 0.8 for a final neural network layer of a model and follow a linear decay rule for other neural network layers. The noise injection logic 170 can be used to apply dropout to a final classification layer with an example dropout rate of 0.5. Other dropout rates may be used as needed. For the RandAugment algorithm, the noise injection logic 170 can be used to apply one or more random operations (e.g., two random operations) with the being magnitude set to an example value of 27. Other magnitude values may be used as desired for the random operations.

As indicated above, the first machine-learning model that represents the teacher model 140 is not noised when that model is learned or when the pseudo labels 160 are generated using that model. However, during the learning of the second data model representing the student model 145, system 100 injects noise to force the student model 140 to endure a harder, more complex, and more challenging learning process than the teacher model 140. In some implementations, the addition of noise with respect to items of the combined dataset 125 that are processed to learn a student model 145 (e.g., a noisy student model) improves the learning process of the student model 145 by enabling the student to learn beyond the baseline knowledge of a prior teacher model 140.

The architecture 110 generates a learned second model in response to processing each of the items in the combined dataset 125, including processing items that represent noise injected in the combined dataset. During a subsequent iteration of processing, the system 100 can also generate second pseudo labeled data by generating a respective pseudo label for each of the multiple items of unlabeled data 150 by processing the items of unlabeled data 150 using the trained/learned second machine-learning model.

The system 100 is operable to train a third machine learning model on a second combined dataset 125 that includes the labeled data 120 and the second pseudo labeled data 160. Each of the second combined dataset 125 and the second pseudo labeled data 160 represent sets of data that are generated for a second (or subsequent) iteration of training or data processing using architecture 110. In some implementations, the trained third machine-learning model represents a second, different version of a student model. Alternatively, the trained third machine-learning model can correspond to a particular version of a trained second machine-learning model produced as a result of a training iteration implemented at architecture 110.

In some implementations, the neural network architecture 110 is configured to generate respective subsequent versions of the teacher model 140 for one or more data processing iterations and generate respective subsequent versions of the student model 145 for one or more data processing iterations. The neural network architecture 110 can then generate a data recognition model based on each of the subsequent versions of the teacher model 140 and each of the subsequent versions of the student model 145.

For example, the system 100 is configured to iterate the process 200 by putting back the student as a teacher, which corresponds to generating subsequent versions of the teacher model 140. In the context of processing images that correspond to labeled and unlabeled data, the trained student model 145 that is put back as the teacher model 140 is configured to minimize the combined cross entropy loss on both labeled images and unlabeled images. The student model 145 that is put back as the teacher model 140 is used to generate new pseudo labels 160 for training a new student model 145 during a subsequent iteration of process 200 (or algorithm 300 described below). The training of the new student model 145 corresponds to generating subsequent versions of the student model 145.

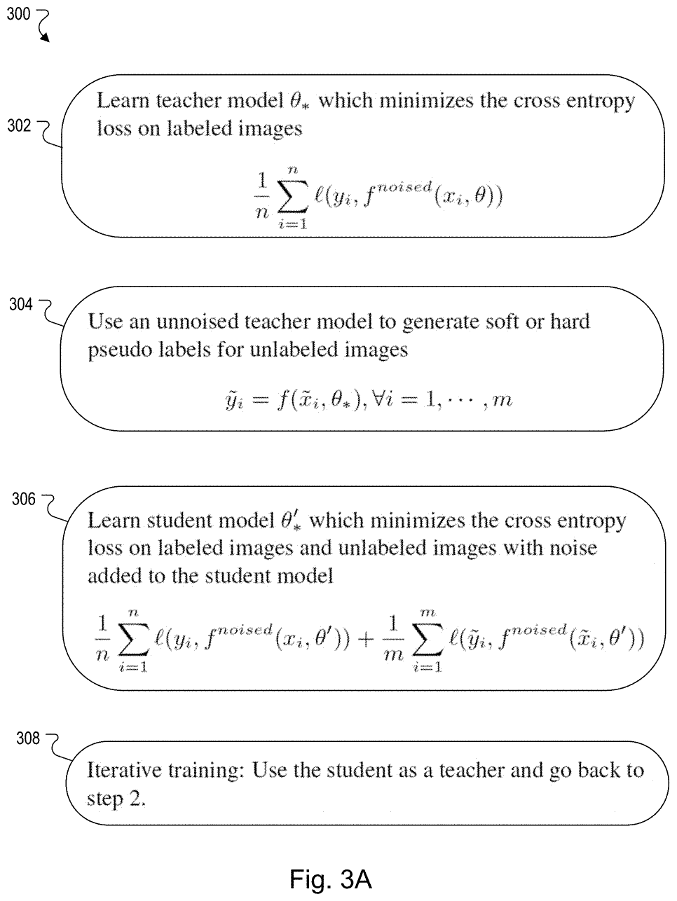

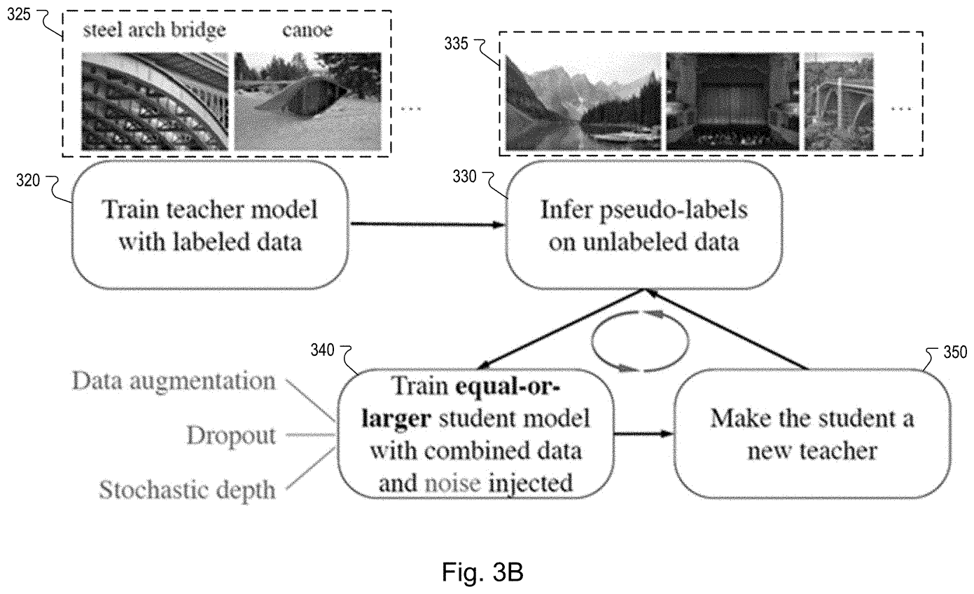

FIG. 3A shows a representative algorithm 300 for implementing the self-training techniques described in this document. The algorithm 300 corresponds to a self-training technique for learning (or training) a neural network model to perform a particular function (e.g., data recognition) and represents a method in semi-supervised learning. The algorithm 300 includes learning a teacher model 140 that is represented as θ in the equation of step 302 in the example of FIG. 3A. The learned teacher model 140 is configured to minimize the cross entropy loss on labeled data/images. The algorithm 300 includes using an un-noised teacher model 140 to generate soft or hard pseudo labels for unlabeled data/images based on the mathematical expression of step 304. The algorithm 300 includes learning a student model 145 that is represented as θ′ in the equation of step 306. The learned student model 145 is configured to minimize the cross entropy loss on labeled data/images and unlabeled data. The student model 145 can be noised during its learning process.

The algorithm 300 includes an optional iterative training step (308), where the learned student model 145 is used as a teacher model 140 and the processing of step 2 is repeated (e.g., iteratively) to cause the last generated student model 145 to be put back as a baseline model to learn a new teacher model 140 that is configured to minimize the cross entropy loss on labeled data/images. The repeated execution of step 308 represents the iterative training of teacher and student by putting back the student as the new teacher to generate new pseudo labels (soft or hard). During this iterative process and training technique, the system 100 and algorithm 300 can include an example step of increasing a size of the student model 145 to improve the performance of the student model 145.

Referencing the EfficientNet models discussed above, an example implementation can include first improving observed accuracy of an EfficientNet-B7 model using the EfficientNet-B7 model as both the teacher and the student. The improved EfficientNet-B7 model is then used as the teacher to train an EfficientNet-L0 model as a new student model 145. Next, the trained EfficientNet-L0 that represents the new student model 145 is put back as a new teacher model 140 to train a student model 145 using the EfficientNet-L1 model, which is a wider (e.g., larger) model than the EfficientNet-L0 model. Next, with the EfficientNet-L1 model as a new teacher model 140, the system 100 and architecture 110 are configured to further increase the size of a subsequent student model 145 to a size of the EfficientNet-L2 model. Lastly, another EfficientNet-L2 is trained as a new student model 145 by using the EfficientNet-L2 model as a subsequent, new teacher model 140.

In some implementations, when the student model is deliberately noised, the system 100 actually trains the model to be consistent to the more powerful teacher model that is not noised when it generates pseudo labels. As noted above, to noise the student model 145, example methods for injecting noise during training of the student model include a dropout method, a data augmentation method, a stochastic depth method, or combinations of each. In some cases noise may appear to be limited and uninteresting when it is applied to unlabeled data. However, noise components can also have a compound benefit of enforcing local smoothness in a decision function on both labeled and unlabeled data. Different kinds of noise, however, may have different effects.

For example, when data augmentation noise is used, the student must ensure that a translated image has the same category with a non-translated image. This corresponds to an invariance constraint that reduces the degrees of freedom in the model. When dropout and stochastic depth are used to inject noise, the teacher model 140 is configured to function as an ensemble of models. In some implementations, when the teacher model 140 generates the pseudo labels 160, the dropout method for injecting noise is used. In contrast to the teacher model 140, the student model 145 functions as a single model. In other words, by configuring the student model 145 to function as a single model, the student may then be forced to mimic a more powerful ensemble of models. For example, the single model that represents the student may be forced to mimic learning processes of a more powerful ensemble of models that represent the teacher.

The labeled data 120 used to train a first, teacher model 140 can include data items from an ImageNet dataset used in an example challenge prediction task, such as a challenge prediction task of the 2012 ImageNet Large Scale Visual Recognition Competition (“2012 ILSVRC”). For example, because it is considered one of the most challenging benchmarks in computer vision, and because improvements on learning from ImageNet datasets transfer to other datasets, the dataset for the challenge prediction task of the 2012 ILSVRC provides a sufficiently complex set of labeled data from which a teacher model can be trained to generate pseudo labels for training a student model.

The unlabeled data 150 used to generate the pseudo labels can include data items such as unlabeled images obtained from an example JFT dataset, e.g., the JFT-300M which has around 300M images. In some implementations, although the images in an example JFT dataset may have labels, the system 100 is operable to ignore or bypass the labels and treat the individual data items of the JFT dataset as unlabeled data.

The system 100 is configured to perform data filtering and balancing on the corpus of unlabeled data. For example, the system 100 is operable to run an example baseline network over the JFT dataset to predict a label for each image or data item. The system 100 can use the baseline network to generate a corresponding confidence (e.g., a numerical score) for a respective predicted label for each image or data item. In some cases, the example baseline network can be a network of CNN layers, such as EfficientNet-B0, that is trained on an ImageNet dataset.

The system 100 can then select data items (or images) that have confidence score of the predicted label that is higher than a threshold confidence score (e.g., higher than 0.3). The data items such as images may belong to different image classes. For each class, the system 100 is operable to select a threshold number of images that have the highest confidence scores for respective predicted labels. For example, the system 100 can select at most 130,000 (“130K”) images that all have confidence scores higher than a threshold score of 0.62.

In some cases, a class may have less than 130K images, for these classes, the system 100 is operable to duplicate random images so that each class can have 130K images. In this manner, the system 100 can be configured such that a total number of images (or data items) that are used for training a student model is 130K or 130M, with some duplicated images. In some implementations, an example dataset of 130M images may include a threshold number of unique images (e.g., 81M unique images) among the 130M images, such that described techniques are robust to the duplications and no extensive tuning of hyper parameters is required.

For labeled images, the system 100 can use an example batch size of 2048. In some examples, the system 100 may use batch sizes such as 512, 1024, and 2048. The system 100 is configured to reduce the batch size based on available memory at the system or based on a threshold amount of memory that is required to fit the model into the resources of the system.

The system 100 is operable to determine a number of training steps or processing iterations and a learning rate schedule based on the batch size for labeled images. For example, the system 100 can train an example student model 145 for 350 epochs when the model is determined to be larger than the EfficientNet-B4 model, including the EfficientNet-L0, L1 and L2 models, described above. The system 100 can train an example student model 145 for 700 epochs for smaller models. In some cases, larger baseline models such as EfficientNet-L2 can be trained for 3.5 days on an example cloud-based learning system with multiple cores, e.g., Cloud TPU v3 Pod, which has 2048 cores. The learning rates employed by the architecture 110 can start at an example setting of 0.128 for a set of labeled data having a batch size of 2048. The system 100 is configured to set a decay value based in part on the training steps or processing iterations.

For example, the starting rate learning rate of 0.128 can be set to decay by a value of 0.97 for every 2.4 epochs if the model is set to be trained for 350 epochs. In another example, the starting rate learning rate of 0.128 can be set to decay by a value of 0.97 for every 4.8 epochs if the model is set to be trained for 700 epochs. In general, an epoch refers to one cycle through a full training dataset, such as a measure of the number of times all of the training vectors are used once to update weights for one or more layers of a neural network 130. In some cases, for batch training, the training samples pass through the learning algorithm simultaneously in one epoch before weights are updated.

For unlabeled data or images, the system 100 is configured to set the batch size to be a multiple of the batch size of the labeled images, particularly for training large models. For example, the system 100 is configured to set the batch size for unlabeled data/images to be three times the batch size of labeled images for large models such as EfficientNet-B7, L0, L1 and L2. For smaller models, the system 100 is configured to set the batch size of unlabeled images to be the same as the batch size of labeled images. In some implementations, labeled images and unlabeled images are concatenated together and the system 100 computes an average cross entropy loss.

System 100 is configured to apply one or more techniques to correct, fix, or otherwise account for train-test resolution discrepancy for certain model types, such as the EfficientNet-L0, L1 and L2 models. For example, the system 100 can perform model training with a smaller resolution dataset for 350 epochs. The system 100 can then fine tune the model with a larger resolution dataset for 1.5 epochs on un-augmented labeled images. The model may include one or more shallow layers and the system 100 is configured to detect or identify the shallow layers and fix the shallow layers during the process of fine tuning the model with the larger resolution dataset.

FIG. 3B illustrates an example of noisy student training. In the example of FIG. 3B, a teacher model is trained with labeled data (320) corresponding to example images 325. Each of the labeled images 325 and the teacher model are un-noised when an example neural network architecture is trained as the teacher model. The system 100 infers pseudo-labels on unlabeled data (330) corresponding to example unlabeled images 335. For instance, the teacher model is used to generate or infer a respective pseudo label for each unlabeled image 335. The system 100 trains an equal-or-larger student model with the combined dataset and noise injected (340). For example, the student model that is trained is sized to be equal to, or larger than, a size of the teacher model. The system 100 makes the trained student model a new teacher and iterates the noisy student training process at least by inferring pseudo-labels on unlabeled data (330), such as unlabeled data corresponding to various types of example unlabeled images 335.

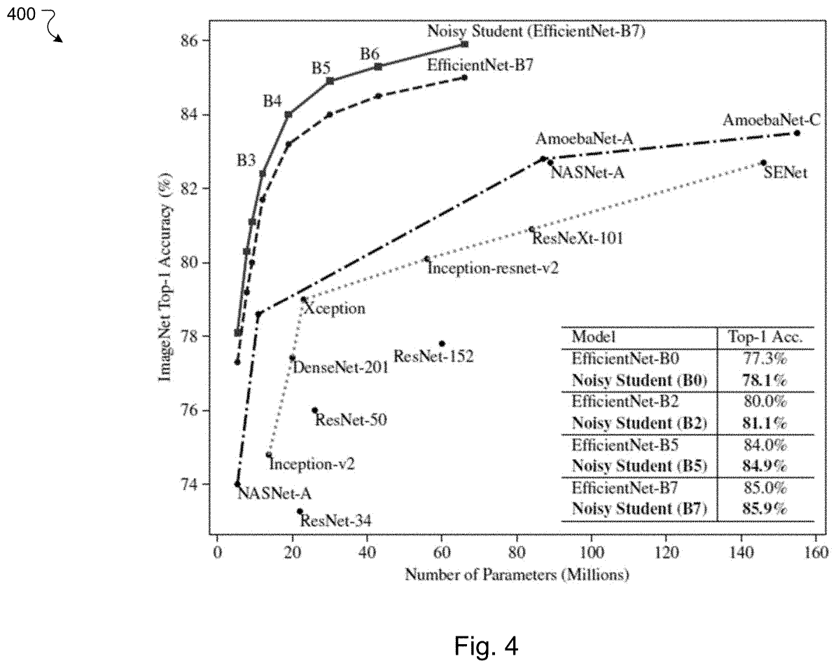

FIG. 4 shows an example graph 400 that includes graphical data about the performance of different models with respect to the self-training techniques. As described above, the techniques for self-training a neural network model by using a noisy student to emphasize the role that noise plays provides a robust method for training models that can achieve more accurate results relative to models developed using other approaches.

The example of FIG. 4 shows that using the noisy student as part of the method for self-training neural network models leads to a consistent improvement of about 0.8% for various model sizes. For example, the graph 400 and its graphical data show that training different EfficientNets models using the noisy student approach provides a much better tradeoff between model size and accuracy when compared with prior works such as NASNet-A, AmoebaNet-A, or AmoebaNet-C. The graph 400 and its graphical data also show that some vision models can benefit from training techniques that involve use of a noisy student even without iterative training.

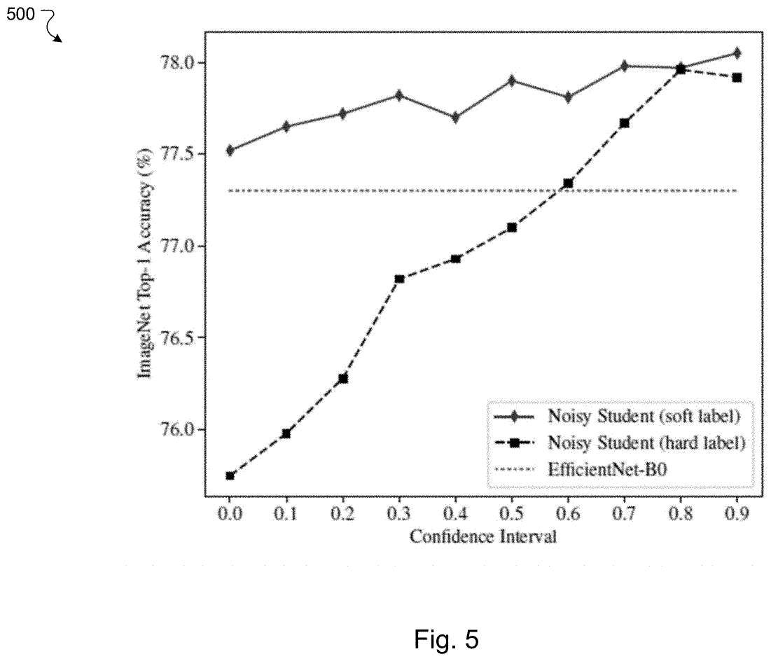

FIG. 5 shows an example graph 500 that includes graphical data about model performance for different types of pseudo labels. In particular, the graphical data of graph 500 indicates that use of soft pseudo labels during self-training of a neural network model can lead to better performance for low confidence data.

A confidence score that is generated by a teacher model 140 confidence for a processed image can indicate whether an image is an out-of-domain image. In view of this, the system 100 is configured to identify images that generate a confidence score above a certain threshold score and to identify images that generate a confidence score below a certain threshold score. The images that have a corresponding confidence score above a certain threshold score are identified as in-domain or high-confidence images. Similarly, the images that have a corresponding confidence score below a certain threshold score are identified as out-of-domain or low-confidence images.

The system 100 is configured to sample different quantities of images over different confidence intervals and assess performance of the model for the different quantities and confidence intervals. For example, the system 100 is configured to sample 1.3M images in confidence intervals [0.0, 0.1], [0.1, 0.2], . . . , [0.9, 1.0]. In some implementations, the architecture 110 uses particular types of models as both the teacher model 140 and the student model 145. For example, the architecture 110 can use an EfficientNet-B0 model as both the teacher model 140 and the student model 145 and compare performance of each model. The performance of the models can be compared in response to training each model using the noisy student approach described above with either soft pseudo labels or hard pseudo labels.

The graphical data of graph 500 shows results of the comparison. The data in graph 500 shows the following observations: (1) soft pseudo labels and hard pseudo labels can both lead to substantial performance improvements with in-domain unlabeled images, i.e., high-confidence images; (2) for out-of-domain unlabeled images, hard pseudo labels can hurt the model performance, whereas the model trained with soft pseudo labels leads to robust performance. In some implementations, using hard pseudo labels can achieve as good results or slightly better results when a larger teacher model is used.

In general, computer vision models developed using prior approaches lack robustness. In other words, small changes in the input image supplied to these computer vision models can cause large changes in the accuracy of the predictions generated by the model. Addressing the lack of robustness has become an important research direction in machine learning and computer vision in recent years. The self-training techniques described in this document demonstrate unlabeled data that is processed and used to learn a model in the manner described above can generate data recognition models with improved accuracy and general robustness relative to vision models developed using the prior approaches.

In some implementations, a trained data recognition model 190 that achieves 88.4% top-1 accuracy is evaluated on different robustness test sets that each include different types of images. In one example the test sets can correspond to: ImageNet-A, ImageNet-C, and ImageNet-P. The test sets can include images that have varying corruption and perturbation attributes. For example, the ImageNet-C and ImageNet-P test sets include images with common corruptions and perturbations such as blurring, fogging, rotation, and scaling. The ImageNet-A test set includes difficult images that cause significant drops in accuracy when processed using prior/conventional models. The test sets can represent “robustness” benchmarks based on the difficult or perturbed images included in the set.

Table 2 below includes robustness results for prior models trained using conventional methods and for the data recognition model 190. The data recognition model 190 is based on an EfficientNet-L2 model trained using processes of algorithm 300, including the noisy student approach in which noise is injected during the iterative training process. The models are evaluated against images of the ImageNet-A test set.

TABLE 2
Robustness results on ImageNet-A

| Method | Top-1 Acc. | Top-5 Acc. |
|---|---|---|
| ResNet-101 | 4.7% | — |
| ResNeXt-101 (32 × 4 d) | 5.9% | — |
| ResNet-152 | 6.1% | — |
| ResNeXt-101 (64 × 4 d) | 7.3% | — |
| DPN-98 | 9.4% | — |
| ResNeXt-101 + SE (32 × 4 d) | 14.2% | — |
| ResNeXt-101 WSL | 16.6% | — |
| EfficientNet-L2 | 49.6% | 78.6% |
| Noisy Student (L2) | 74.2% | 91.3% |

Table 3 below includes robustness results for the prior models noted above and for the data recognition model 190 noted above that is based on the EfficientNet-L2 model. The models are evaluated against images of the ImageNet-C test set. The mean corruption error (mCE) value for each method is the weighted average of error rate for different corruptions. A lower mCE value corresponds to better performance.

TABLE 3
Robustness results on ImageNet-C

| Method | Res. | Top-1 Acc. | mCE |
|---|---|---|---|
| ResNet-50 | 224 | 39.0% | 76.7 |
| SIN | 224 | 45.2% | 69.3 |
| Patch Guassian | 299 | 52.3% | 60.4 |
| ResNeXt-101 WSL | 224 | — | 45.7 |
| EfficientNet-L2 | 224 | 62.6% | 47.5 |
| Noisy Student (L2) | 224 | 72.8% | 34.7 |
| EffcientNet-L2 | 299 | 66.6% | 42.5 |
| Noisy Student (L2) | 299 | 75.5% | 31.2 |

Table 4 below includes robustness results for the prior models noted above and for the data recognition model 190 noted above that is based on the EfficientNet-L2 model. The models are evaluated against images of the ImageNet-P test set. In some implementations, the images of the ImageNet-P test set are generated with a sequence of perturbations. The mean flip rate (mFR) measures the model's probability of flipping predictions under perturbations. A lower mFR corresponds to better performance.

TABLE 4
Robustness results on ImageNet-P

| Method | Res. | Top-1 Acc. | mFR |
|---|---|---|---|
| ResNet-50 | 224 | — | 58.0 |
| Low Pass Filter Pooling | 224 | — | 51.2 |
| ResNeXt-101 WSL | 224 | — | 27.8 |
| EffiecientNet-L2 | 224 | 80.4% | 27.2 |
| Noisy Student (L2) | 224 | 83.1% | 17.8 |
| EfficientNet-L2 | 299 | 81.6% | 23.7 |
| Noisy Student (L2) | 299 | 84.3% | 16.1 |

As shown in Table 2, 3, and 4, when compared with the prior models such as ResNeXt-101 WSL trained on 3.5B weakly labeled images, the Noisy Student (L2) model yields substantial gains on the robustness datasets. For example, on the ImageNet-C test/data set, the Noisy Student (L2) reduces the observed mCE from 45.7 to 31.2. Also, on the ImageNet-P dataset the Noisy Student (L2) leads to an mFR of 17.8 for images with a resolution of 224×224 (direct comparison) and to an mFR of 16.1 for images with a resolution of 299×299.1.

These significant gains in robustness for the Noisy Student (L2) model on the ImageNet-C and ImageNet-P test sets were observed even though the models were not deliberately optimized for robustness (e.g., via data augmentation). Significant gains were also observed for ImageNet-A test set. For example, the Noisy Student (L2) method for developing a model yielded a model that achieves 3.5× higher accuracy on the ImageNet-A test, going from a 16.6% Top-1 accuracy for a model developed using conventional approaches to a 74.2% top-1 accuracy for the Noisy Student (L2) model.

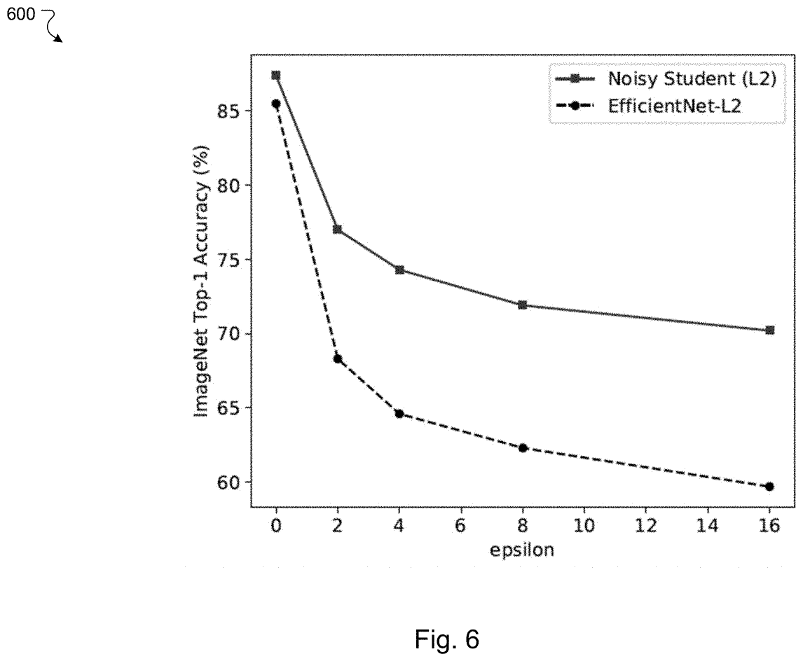

FIG. 6 shows a graph 600 with example graphical data about model performance for a noised model. In the example of FIG. 6, the data of graph 600 indicates that using the noisy student approach for self-training neural network models can improve adversarial robustness against a fast gradient signed method (FGSM) attack, even though the model is not directly optimized for adversarial robustness. For example, the model accuracy can be improved by about 10% in most settings relative to other approaches.

In general, an adversarial example or attack relates to specialized inputs that are created to confuse a neural network model to cause misclassification of a given input or input image. The FGSM is an example adversarial attack method that uses the gradients of the neural network to create an adversarial example. For an input image, the method uses the gradients of the loss with respect to the input image to create a new image that maximizes the loss. This new image is called the adversarial image.

In the example of FIG. 6, the performance against adversarial perturbations is evaluated for different approaches to training models. For example, the EfficientNet-L2 models are evaluated with and without noisy student against an example FGSM attack. In some implementations, the attack performs one gradient descent step on an input image with the update on each pixel set to E. As shown in FIG. 6, noisy student leads to approximately 10% improvement in accuracy even though the model is not optimized for adversarial robustness.

The techniques described in this specification demonstrate the importance that noise can play in self-training a data model. In some implementations, when soft pseudo labels generated from the teacher model 140 are used, and the student model 145 is trained to be exactly the same as the teacher model 140, the cross entropy loss on unlabeled data 150 would be zero and the training signal would vanish. Hence, a question that naturally arises is why the student can out-perform the teacher with soft pseudo labels. As stated earlier, the system 100 can determine that noising the student model 145 is needed so that the student model 145 does not merely learn the teacher's knowledge.

The importance of noising can be assessed in at least two examples that each involve different amounts of unlabeled data and different teacher model accuracies. In both examples noising due to data augmentation, stochastic depth, and dropout are gradually removed for unlabeled images, while the noising is kept for labeled images. This allows for isolating the influence of noising on unlabeled images from the influence of preventing overfitting for labeled images.

TABLE 5
Ablation Assessment on Noising

| Model/Unlabeled Set Size | 1.3M | 130M |
|---|---|---|
| EfficientNet-B5 | 83.3% | 84.0% |
| Noisy Student (B5) | 83.9% | 84.9% |
| w/o Aug | 83.6% | 84.6% |
| w/o Aug, SD, Dropout | 83.2% | 84.3% |

The EfficientNet-B5 can be used as the baseline model and the two examples can also involve different types of augmentations with the different number of unlabeled images (e.g., Unlabeled Set Size). For an example implementation involving 1.3M unlabeled images, the system 100 uses standard augmentation including random translation and flipping for both the teacher and the student models. For the example with 130M unlabeled images, the system 100 uses the RandAugment algorithm. In Table 5 above, the “Aug” and “SD” denote data augmentation and stochastic depth, respectively. As indicated above, the noise can be removed for unlabeled images (e.g., gradually), whereas the noise can be kept for labeled images. Iterative training may or may not be used in some instances.

The result data of Table 5 shows that noise from functions such as stochastic depth, dropout, and data augmentation can play an important role in enabling a student model 145 to perform better than a teacher model 140. In some cases the performance consistently drops with the noise function removed. For example, with all noise removed, the accuracy drops from 84.9% to 84.3% in the case with 130M unlabeled images and drops from 83.9% to 83.2% in the case with 1.3M unlabeled images. However, in the case with 130M unlabeled images, when the noise function is removed, the performance is still improved to 84.3% from 84.0% when compared to the supervised baseline (e.g., EfficientNet-B5). This improvement can be attributed to stochastic gradient descent (SGD), which introduces stochasticity into the training process. In some implementations, removing noise leads to a much lower training loss for labeled images. For unlabeled images, removing noise can lead to a smaller drop in training loss.

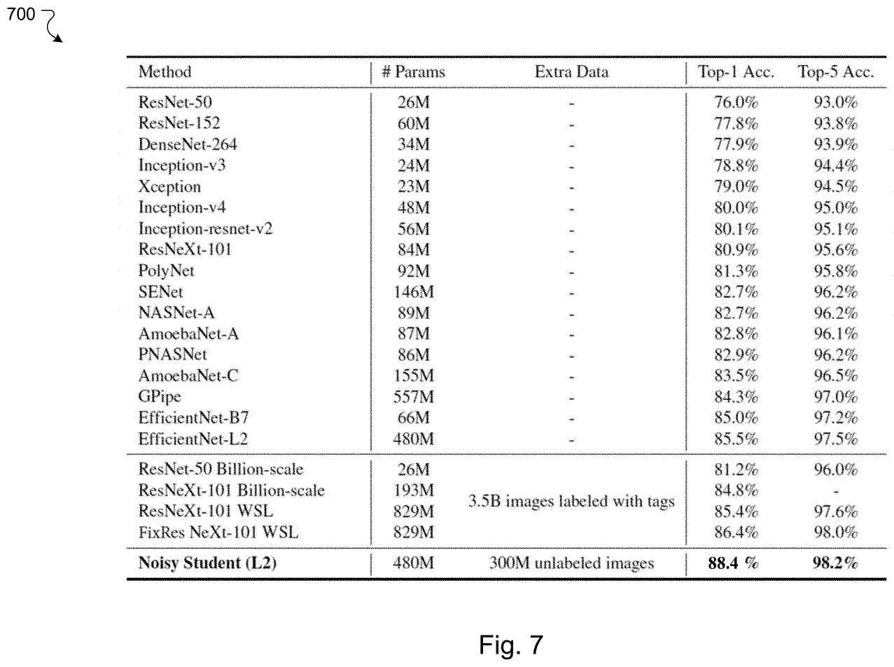

FIG. 7 shows results data 700 that includes accuracy values for different types of models. The results data 700 shows accuracy values for Top-1 and Top-5 Accuracy with respect to processing ImageNet images on noisy student (L2) models and on other models developed using prior training approaches. The results data 700 indicates that models (e.g., EfficientNet-L2) developed using the described self-training techniques, including the noisy student methods, have better tradeoff in terms of accuracy and model size when compared to models trained using conventional methods. In some implementations, the accuracy values for Noisy Student (EfficientNet-L2) is the result of iterative training for multiple iterations.

As shown at results data 700, Noisy Student with EfficientNet-L2 achieves 88.4% top-1 accuracy, which is significantly better than the best previously reported accuracy on EfficientNet of 85.0%. The gain of 2.4% can be attributed sources such as making the model larger (+0.5% gain) and by incorporating the Noisy Student (+1.9% gain). In other words, this indicates that using the Noisy Student can have a larger impact on the accuracy than changing the model architecture, e.g., by making the model larger.

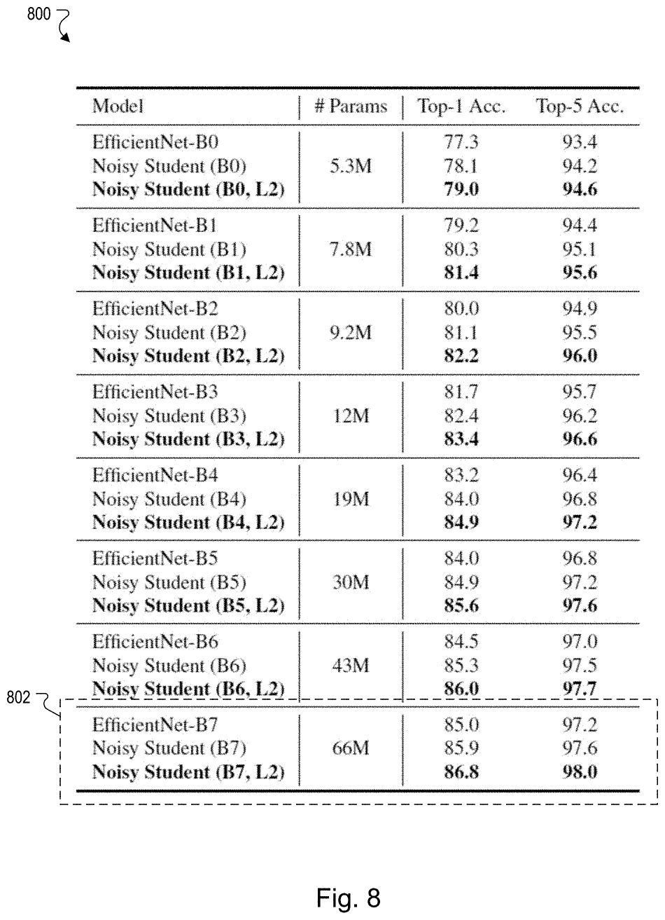

FIG. 8 shows results data 800 with accuracy values for different types of noised models. The iterative self-training techniques that include the noisy student method for learning a neural network model allows for the model's to performance improve with more unlabeled data 150. In some implementations, the architecture 110 is configured such that the capacity of a student model 145 is as large as, or larger than, the capacity of a teacher model 140. In other implementations, performance on small student models 145 can be improved by using a larger teacher model 140. In general, small data models can be useful when there are constraints for model size and latency in real-world applications.

The results data 800 include observed accuracy values for examples in which a high-performing Noisy Student with EfficientNet-L2 model (e.g., a teacher model 140) is used to teach student models 145 with model sizes ranging from such as EfficientNet-B0 to EfficientNet-B7. These student models 145 can be learned using standard augmentation or a RandAugment algorithm for performing data augmentation. The outcome of a comparison between the different model sizes is indicated results data 800. For example, as shown in results data 800, using the Noisy Student (EfficientNet-L2 model) self-training technique as the teacher leads to another 0.8% improvement on top of the improved results discussed above.

Notably, the EfficientNet-B7 model (with Noisy Student) achieves an accuracy of 86.8%, which is 1.8% better than the supervised model, e.g., EfficientNet-B7 model (without Noisy Student). This shows that it is helpful to train a large model, e.g., a teacher model 140, with high accuracy using the noisy student method when small models are needed for deployment. More specifically, this shows that a self-training technique of developing a large teacher model 140, with high accuracy, by using the noisy student method can yield small models with improved performance relative to the teacher model.

Referring again to results data 800, for examples 802, “Noisy Student (B7, L2)” means to use an EfficientNet-B7 model as a student model 145 and to use a best performing model, Noisy Student (L2), with 88.4% accuracy (see results data 700 at FIG. 7) as a teacher model 140. In a related case, “Noisy Student (B7)” means to use an EfficientNet-B7 model for both the student model 145 and the teacher model 140. For a small student model 145, using the best performing Noisy Student model (EfficientNet-L2) as the teacher model 140 leads to more improvements than using the same model as the teacher. This further supports the notion that it is helpful to train a large model when small models are needed for deployment.

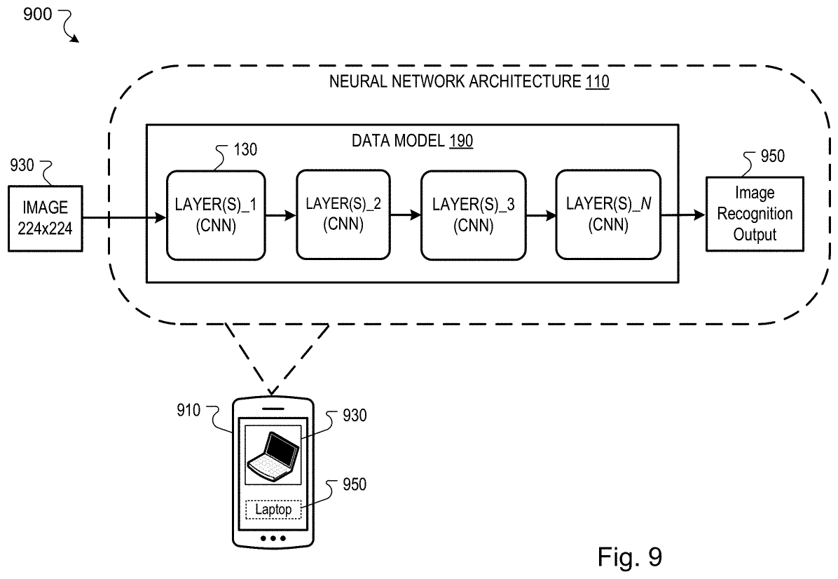

FIG. 9 shows an example system 900 that includes neural network model for performing data recognition. More specifically, in the example of FIG. 9, a user device 910 is configured to run an example data recognition model 190. The data recognition model 190 is learned using neural network architecture 110 and the self-training techniques described in this document to train one or more neural networks 130. For example, the neural networks 130 may be trained using the algorithm 300, including the noisy student method, and the iterative processing techniques described above.

The user device 910 can be a mobile/client device, such as a smart phone, tablet, or laptop computer. In some implementations, the user device 910 is any electronic device that is capable of accessing or running a neural network model, such as a smart television, a gaming console, an augmented/virtual/mixed reality device, or desktop computer. The neural network architecture 110 may be local or remote relative to the user device 910. For instance, in some cases the data model 190 is run or accessed locally at the user device 910, whereas in other cases the data model 190 is run or accessed remotely relative to a location of the user device 910.

The data recognition model 190 can be trained to perform image recognition in response to processing an input image 930. For example, the data recognition model 190 is configured to process the input image 930 through one or more neural network layers (e.g., CNN layers) of the data recognition model 190 to detect one or more objects in the image 930. The data recognition model 190 is configured to generate a prediction 950 that identifies or describes the object detected in the input image 930. In the example of FIG. 9, the input image 930 includes an object that is (or resembles) a laptop computer and the data recognition model 190 is configured to generate a prediction 950 that identifies or describes the object as a “Laptop.”

In some implementations, the data recognition model 190 is an example model that is learned using the noisy student method of the self-training techniques described in this specification. The data recognition model 190 is configured to successfully predict the correct labels for highly difficult images and generate accurate descriptions for objects in the difficult (or highly difficult) images. For example, the input image 930 can be a particularly difficult or blurry image with an object that only loosely resembles a laptop computer and the data recognition model 190 is configured to accurately predict the correct labels and corresponding description for object (950). In some examples, the data recognition model 190 is learned with the noisy student method and configured to generate correct predictions for various types of input images 930, including images that are subjected to severe corruptions and perturbations such as snow, motion blur, and fog.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer.

Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
obtaining data specifying a trained first machine-learning model that has been trained on labeled data, wherein each of the labeled data and the first machine-learning model are un-noised when the first machine-learning model is trained and the first machine-learning model is a neural network;
generating first pseudo labeled data by generating a respective pseudo label for each of a plurality of items of unlabeled data by processing the items of unlabeled data using the trained first machine-learning model; and
training a second machine-learning model on a first combined dataset, wherein the first combined dataset comprises the labeled data and the first pseudo labeled data and the second machine-learning model is a neural network, the training comprising:
during the training, adding noise to the second machine-learning model, comprising (i) modifying attributes of one or more items in the first combined data set, (ii) modifying operations performed by the second machine-learning model, or (iii) both.

2. The method of claim 1, comprising:
generating second pseudo labeled data by generating a respective pseudo label for each of the plurality of items of unlabeled data by processing the items of unlabeled data using the trained second machine-learning model; and
training a third machine-learning model on a second combined dataset that includes the labeled data and the second pseudo labeled data.

3. The method of claim 2, wherein training the second machine-learning model comprises:
training a machine-learning model that has a respective model size that is larger than a respective model size of the first machine-learning model that has been trained on the labeled data.

4. The method of claim 2, wherein training the second machine-learning model comprises:
training one or more subsequent versions of the second machine-learning model; and
increasing a respective size of each subsequent version of the second machine-learning model, relative to a respective size of a corresponding prior version of the second machine-learning model that preceded the subsequent version.

5. The method of claim 4, wherein training the third machine-learning model comprises:
training the third machine-learning model based on each of the subsequent versions of the second machine-learning model.

6. The method of claim 4, wherein training the third machine-learning model comprises:
adding noise to the third machine-learning model by modifying attributes of one or more items in the second combined data set using a noise function.

7. The method of claim 4, wherein training the second machine-learning model comprises:
during the training, applying a noise function to a particular neural network layer of the neural network that is used to implement the second machine-learning model;
adding noise to the second machine-learning model based on the noise function applied to the particular neural network layer; and
modifying operations performed by the second machine-learning model as a result of adding the noise to the second machine-learning model.

8. The method of claim 1, wherein generating the respective pseudo label for each of the plurality of items of unlabeled data comprises:
generating the respective pseudo label based on a maximum predicted probability for a class that corresponds to a particular item of unlabeled data in response to processing the particular item of unlabeled data using the trained first machine-learning model.

9. The method of claim 1, wherein modifying attributes of the one or more items in the first combined dataset comprises:
modifying attributes of the one or more items in the first combined dataset to inject noise into the first combined dataset concurrent with processing the one or more items through layers of the neural network to train the second machine-learning model, wherein the neural network is used to implement the second machine-learning model.

10. The method of claim 4, wherein:
the first machine-learning model is implemented using a teacher neural network model;
the second machine-learning model represents a first version of a student neural network model; and
the third machine-learning model represents a second, different version of a student neural network model.

11. The method of claim 10, wherein the first neural network and the second neural network have the same neural network architecture.

12. A system comprising:
one or more processing devices; and
one or more non-transitory machine-readable storage devices storing instructions that are executable by the one or more processing devices to cause performance of operations comprising:
obtaining data specifying a trained first machine-learning model that has been trained on labeled data, wherein each of the labeled data and the first machine-learning model are un-noised when the first machine-learning model is trained and the first machine-learning model is a neural network;
generating first pseudo labeled data by generating a respective pseudo label for each of a plurality of items of unlabeled data by processing the items of unlabeled data using the trained first machine-learning model; and
training a second machine-learning model on a first combined dataset, wherein the first combined dataset comprises the labeled data and the first pseudo labeled data and the second machine-learning model is a neural network, the training comprising:
during the training, adding noise to the second machine-learning model, comprising (i) modifying attributes of one or more items in the first combined data set, (ii) modifying operations performed by the second machine-learning model, or (iii) both.

13. The system of claim 12, comprising:
generating second pseudo labeled data by generating a respective pseudo label for each of the plurality of items of unlabeled data by processing the items of unlabeled data using the trained second machine-learning model; and
training a third machine-learning model on a second combined dataset that includes the labeled data and the second pseudo labeled data.

14. The system of claim 13, wherein training the second machine-learning model comprises:
training a machine-learning model that has a respective model size that is larger than a respective model size of the first machine-learning model that has been trained on the labeled data.

15. The system of claim 13, wherein training the second machine-learning model comprises:
training one or more subsequent versions of the second machine-learning model; and
increasing a respective size of each subsequent version of the second machine-learning model, relative to a respective size of a corresponding prior version of the second machine-learning model that preceded the subsequent version.

16. The system of claim 15, wherein training the third machine-learning model comprises:
training the third machine-learning model based on each of the subsequent versions of the second machine-learning model.

17. The system of claim 15, wherein training the third machine-learning model comprises:
adding noise to the third machine-learning model by modifying attributes of one or more items in the second combined data set using a noise function.

18. The system of claim 15, wherein training the second machine-learning model comprises:
during the training, applying a noise function to a particular neural network layer of the neural network that is used to implement the second machine-learning model;
adding noise to the second machine-learning model based on the noise function applied to the particular neural network layer; and
modifying operations performed by the second machine-learning model as a result of adding the noise to the second machine-learning model.

19. The system of claim 12, wherein generating the respective pseudo label for each of the plurality of items of unlabeled data comprises:
generating the respective pseudo label based on a maximum predicted probability for a class that corresponds to a particular item of unlabeled data in response to processing the particular item of unlabeled data using the trained first machine-learning model.

20. One or more non-transitory machine-readable storage devices storing instructions that are executable by one or more processing devices to cause performance of operations comprising:
obtaining data specifying a trained first machine learning model that has been trained on labeled data, wherein each of the labeled data and the first machine-learning model are un-noised when the first machine-learning model is trained;
generating first pseudo labeled data by generating a respective pseudo label for each of a plurality of items of unlabeled data by processing the items of unlabeled data using the trained first machine-learning model; and
training a second machine-learning model on a first combined dataset, wherein the first combined dataset comprises the labeled data and the first pseudo labeled data, the training comprising:
during the training, adding noise to the second machine-learning model, comprising (i) modifying attributes of one or more items in the first combined data set, (ii) modifying operations performed by the second machine-learning model, or (iii) both.
